(19) United States
(12) Patent Application Publication
(10) Pub. No.: US 2026/0012396 A1
(43) Pub. Date: Jan. 8, 2026

(54) Methods And Apparatus For Evaluating Performance Of A Prediction Model

(71) Applicant: MediaTek Inc., Hsinchu City (TW)

(72) Inventors: Kai-Po Chang, Hsinchu City (TW); Miao Wang, Beijing (CN)

(21) Appl. No.: 19/232,765

(22) Filed: Jun. 9, 2025

(30) Foreign Application Priority Data
Jul. 2, 2024 (WO) PCT/CN2024/103184

(51) Int. Cl. H04L 41/149; H04L 27/26; H04W 72/044

(52) U.S. Cl. CPC H04L 41/149; H04L 27/261; H04W 72/044

(57) ABSTRACT

Methods and apparatus pertaining to performance evaluation of a prediction model utilized in mobile communications are described. A test equipment transmits one or more reference signals to a communication apparatus. Then, the test equipment receives one or more prediction results from the communication apparatus. The one or more prediction results are output by a model of the communication apparatus based on the one or more reference signals. The test equipment further determines a performance indicator of the model according to the one or more prediction results.

### CROSS REFERENCE TO RELATED PATENT APPLICATION(S)

The present disclosure is part of a non-provisional application claiming the priority benefit of PCT Application No. PCT/CN2024/103184, filed 2 Jul. 2024, the content of which herein being incorporated by reference in its entirety.

### TECHNICAL FIELD

The present disclosure is generally related to mobile communications and, more particularly, to performance evaluation of a prediction model utilized in mobile communications.

### BACKGROUND

Unless otherwise indicated herein, approaches described in this section are not prior art to the claims listed below and are not admitted as prior art by inclusion in this section.

In the field of mobile communications, over the air (OTA) test is a crucial method for evaluating wireless performance. It is typically conducted in an anechoic chamber or a shielded test space to replicate real-world transmission conditions, ensuring stable connectivity across various environments. This test scheme plays a vital role in assessing the communication quality and efficiency of communication devices and verifying their compliance with national regulations and industry standards.

During the OTA test, a specialized test equipment may adjust multiple parameters to simulate diverse wireless communication environments and evaluate device performance. For instance, modifying the number and arrangement of the antennas enables the analysis of wireless efficiency under different antenna configurations. The results of OTA test directly influence a device's market competitiveness, providing insights into its communication quality, connection stability, data transmission speed, and overall user experience. However, overly complex testing procedures lead to long testing times and significant equipment and labor costs.

Accordingly, how to optimize the OTA testing process to improve efficiency while ensuring compliance with verification requirements is an important issue for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to optimization of the OTA testing process.

In one aspect, a method may involve a test equipment transmitting one or more reference signals to a communication apparatus and receiving one or more prediction results from the communication apparatus. The one or more prediction results are output by a model of the communication apparatus based on the one or more reference signals. The method may also involve the test equipment determining a performance indicator of the model according to the one or more prediction results.

In one aspect, a test equipment may involve a transceiver which, during operation, wirelessly communicates with at least one communication apparatus. The test equipment may also involve a processor communicatively coupled to the transceiver. The processor, during operation, may perform operations comprising transmitting, via the transceiver, one or more reference signals to the communication apparatus and receiving, via the transceiver, one or more prediction results from the communication apparatus. The one or more prediction results are output by a model of the communication apparatus based on the one or more reference signals. The processor may also perform operations comprising determining a performance indicator of the model according to the one or more prediction results.

In one aspect, a method may involve a communication apparatus receiving one or more reference signals from a test equipment by using a predetermined receiving beam and generating one or more prediction results based on the one or more reference signals. The one or more prediction results comprise one or more received power indicators predicted in a time domain or a spatial domain. The method may also involve the communication apparatus transmitting the one or more prediction results to the test equipment.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a measurement procedure in accordance with implementations of the present disclosure.

FIG. 2 is a diagram depicting an example scenario of an AI/ML model assisting in measurement prediction in accordance with implementations of the present disclosure.

FIG. 3 is a diagram depicting an example scenario of a test environment in accordance with implementations of the present disclosure.

FIG. 4 is a diagram depicting an example communication system having an example communication apparatus and an example test equipment in accordance with an implementation of the present disclosure.

FIG. 5 is a diagram depicting an example process in accordance with an implementation of the present disclosure.

FIG. 6 is a diagram depicting another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to performance evaluation of a prediction model utilized in mobile communications. According to the present disclosure, a number of possible solutions may be implemented separately or jointly. That is, although these possible solutions may be described below separately, two or more of these possible solutions may be implemented in one combination or another.

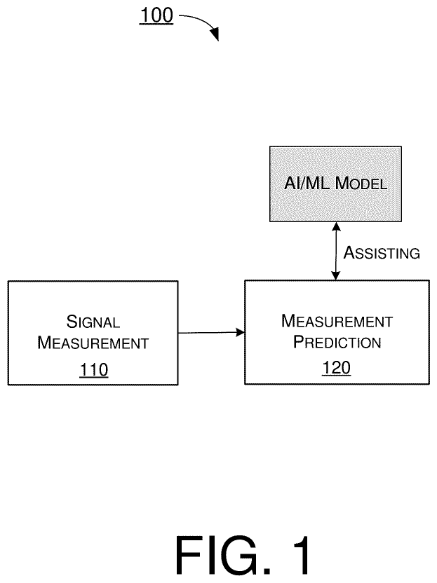

FIG. 1 illustrates an example scenario 100 of a measurement procedure in accordance with implementations of the present disclosure. The measurement procedure may comprise several operations, such as signal measurement 110 and measurement prediction 120. In the signal measurement 110, one or more signals or beams may be measured to generate a measurement result. The measurement result may comprise information regarding received power of the one or more signals or beams. In the measurement prediction 120, possible/potential received power of one or more unmeasured signals or beams may be predicted or determined based on the measurement result obtained via the signal measurement 110.

In some implementations, an artificial intelligence or machine learning model (AI/ML model) may be involved in the operation of measurement prediction 120, to assist in determining the possible received power of the one or more unmeasured signals or beams based on the obtained measurement result. For example, the AI/ML model may be capable of performing an interpolation or other calculation operation to obtain the predicted received power of the beams in the directions that are not measured or the predicted received power at the points on the timeline that are not measured. In some implementations, with the measurement prediction 120, more measurement results in time domain or spatial domain may be obtained.

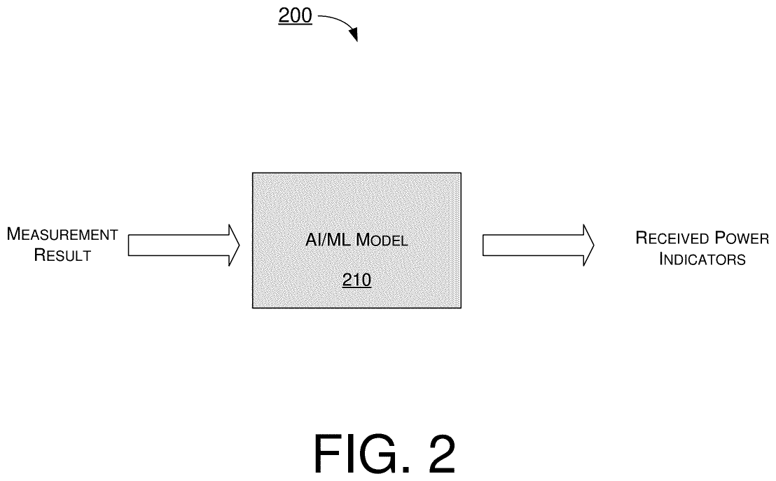

FIG. 2 illustrates an example scenario 200 of an AI/ML model assisting in measurement prediction in accordance with implementations of the present disclosure. The input of the AI/ML model 210 may comprise the measurement result obtained through the actual measurement performed on one or more received signals, and the output of the AI/ML model 210 may comprise one or more received power indicators. In some implementations, the input of the AI/ML model 210 may further comprise an angle of arrival (AoA) associated with the received signals. In some implementations, the received power indicators output by the AI/ML model 210 may comprise the received power indicators associated with the actually measured signals and the predicted or inferred received power indicators associated with the signals that have not been measured.

In some implementations, the output of the AI/ML model 210 may further comprise predicted or inferred transmitting beam information (e.g., the best beam, quality of beam, etc.), in an event that not all transmitting beams have been actually measured. In some implementations, the AI/ML model 210 may use incomplete measurement(s) to predict the whole transmitting beams' information based on the time or spatial correlation between the transmitting beams. In some implementations, the output of the AI/ML model 210 may further comprise predicted or inferred future Tx beam information.

Instead of transmitting and measuring the signals or beams in every direction or in every point on the timeline that requires measurement, with the assistance of the AI/ML model, the number of signals or beams to be transmitted and measured may be significantly reduced.

In some implementations, the measurement prediction with an AI/ML model (e.g., the measurement prediction 120 in FIG. 1) may be performed by a communication apparatus (e.g., a UE) in mobile communications.

In some implementations, to test, evaluate or assess the performance of the AI/ML model, some over the air (OTA) tests with respect to the communication apparatus may be conducted. For example, a number of predefined beams are transmitted by a test equipment to test, evaluate or assess the performance of the AI/ML model. In another example, signals or beams in a number of predefined directions or at a number of predefined points on the timeline are transmitted by the test equipment to test, evaluate or assess the performance of the AI/ML model.

It is worth noting that in order to simulate wireless signals from various directions or different paths in the OTA test, multi-angle and multi-path channel models have to be established. However, as the number of directions or paths to be simulated increases, both the test system architecture and procedures become more complex, which leads to higher deployment and test costs.

To address these issues, method and apparatus for evaluating performance of a prediction model are provided. This solution simplifies the test system architecture and procedures, significantly reducing the overall deployment cost of the OTA test.

In some implementations, the method for evaluating performance of a prediction model of the communication apparatus may be performed by the test equipment in a test procedure.

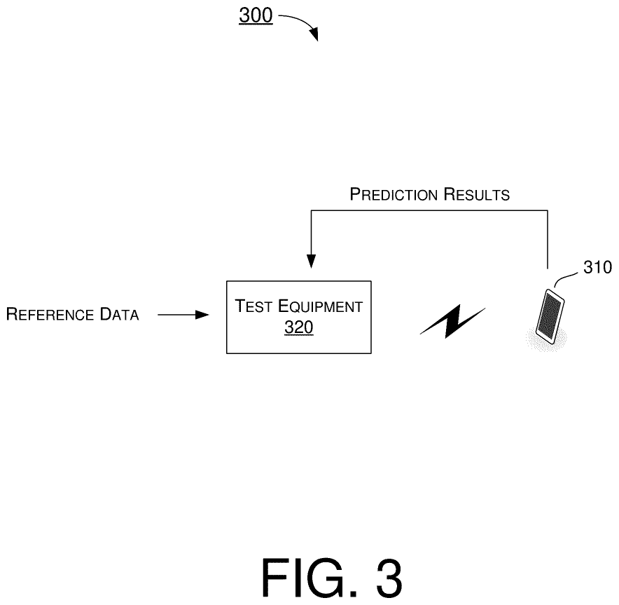

FIG. 3 illustrates an example scenario 300 of a test environment in accordance with implementations of the present disclosure. The test environment may comprise a communication apparatus 310 (e.g., a UE) and a test equipment 320. In some implementations, the communication apparatus 310 and the test equipment 320 may be placed in an anechoic chamber or a shielded test space.

In some implementations, in the test procedure, the test equipment 320 may transmit one or more reference signals to the communication apparatus 310, receive one or more prediction results from the communication apparatus 310, and determine a performance indicator of a model (such as the AI/ML model 210 in FIG. 2) of the communication apparatus 310 according to the one or more prediction results. In some implementations, the one or more prediction results may be output by the model of the communication apparatus 310 based on the one or more reference signals.

In some implementations, the one or more reference signals may be transmitted according to an AoA associated with the communication apparatus 310. In some implementations, the AoA may be fixed when transmitting the one or more reference signals. In some implementations, a single AoA may be used to transmit the one or more reference signals. In some implementations, instead of implementing multiple AoAs for a number of different transmitting beams, only one AoA is used in the test procedure.

In some implementations, the one or more prediction results may comprise one or more received power indicators predicted in a time domain. In some implementations, the one or more prediction results may comprise one or more received power indicators predicted in a spatial domain. In some implementations, the received power indicators may comprise a reference signals received power (RSRP), a reference signal received quality (RSRQ), a signal to interference plus noise ratio (SINR), or the like.

In some implementations, the test equipment 320 may transmit a configuration to the communication apparatus 310. In some implementations, the configuration may indicate whether a time domain prediction or a spatial domain prediction is to be performed.

In some implementations, the test equipment 320 may control a transmission power of the one or more reference signals. In some implementations, the test equipment 320 may simulate transmitting and receiving behaviors of a network node, such as a base station, and the configurations and implement consideration for both the network node (e.g., the test equipment 320) and the communication apparatus 310 may be implicitly reflected on the transmission power of the one or more reference signals.

In some implementations, the transmission power may reflect at least one of a communication channel (e.g., a channel between the network node (the test equipment 320) and the communication apparatus 310), a number of transmitting beams of the network node (the test equipment 320), an antenna configuration of the network node (the test equipment 320), an antenna radiation pattern of the network node (the test equipment 320), an antenna configuration of the communication apparatus 310, an antenna radiation pattern of the communication apparatus 310 and a speed of the communication apparatus 310.

In some implementations, the test equipment 320 may change the transmission power of the one or more reference signals to simulate or replicate different wireless propagation scenarios of the one or more reference signals. In some implementations, by changing the transmission power of the one or more reference signals, the test equipment 320 may simulate or replicate different channel conditions or different channel impulse responses, different numbers of transmitting beams, and different antenna configurations or different antenna radiation patterns of the test equipment 320. Similarly, in some implementations, by changing the transmission power of the one or more reference signals, the test equipment 320 may simulate or replicate different antenna configurations or different antenna radiation patterns of the communication apparatus 310, or different speeds of the communication apparatus 310.

In some implementations, as the configurations and implement consideration for both the test equipment 320 and the communication apparatus 310 are reflected on the transmission power, only a single-angle signal (e.g., single AoA) is used to simulate the entire multi-signal directions, which eliminates the need to fully replicate a multi-angle transmission environment in the test procedure.

In some implementations, before conducting the test procedure, the test equipment 320 may conduct a calibration procedure. In some implementations, in the calibration procedure, the test equipment 320 may transmit a calibration signal with a predetermined power to the communication apparatus 310 before transmitting the one or more reference signals, receive a metric value associated with the calibration signal from the communication apparatus 310 and determine a transmission power of the one or more reference signals according to a relationship between the metric value and the predetermined power.

In some implementations, the test equipment 320 may use the reported metric value and the predetermined power to determine the relationship (e.g., a ratio between transmitted power and reported RSRP value). In some implementations, the test equipment 320 may derive the receiving gain of the communication apparatus 310 according to the relationship, which allows the test equipment 320 to know how to configure the transmission power to meet a target metric value, so as to reduce the impact of the receiving gain of the communication apparatus 310.

In some implementations, the test equipment 320 may test or evaluate different communication apparatuses based on a reference transmission power, which may be a unified value. In some implementations, the test equipment 320 may determine a specific transmission power offset for the communication apparatus 310 based on the aforementioned relationship obtained in the calibration procedure, for the reported metric value of the communication apparatus 310 to meet the target metric value. In some implementations, different communication apparatuses may have different amounts of transmission power offset to compensate for the differences in receiving gain among them.

In some implementations, the AoA of the calibration signal and the AoA of the one or more reference signals may be the same. In some implementations, in the calibration procedure and the test procedure, the AoA may be fixed.

In some implementations, the test equipment 320 may keep all environment settings, including the AoA direction, utilized in the calibration procedure and use them in the test procedure. In some implementations, the test equipment 320 may control the transmission power based on the aforementioned relationship or transmission power offset obtained in the calibration procedure to ensure target metric value is fed into the model of the communication apparatus 310.

In some implementations, the test equipment 320 may further receive and store reference data utilized in evaluation when determining the performance indicator of the model of the communication apparatus 310.

In some implementations, the reference data may be obtained from a simulation or field collection. In some implementations, the test equipment 320 may compare the reference data and the one or more prediction results reported by the communication apparatus 310 to evaluate the performance of the model. For instance, the performance indicator may be an accuracy or a score of the prediction performed by the model of the communication apparatus 310 and may indicate the performance of the model.

Regarding the operations of the communication apparatus 310 in the test procedure, in some implementations, the communication apparatus 310 may receive the one or more reference signals from the test equipment 320 by using a predetermined receiving beam, generate one or more prediction results based on the one or more reference signals and transmit the one or more prediction results to the test equipment 320. In some implementations, the one or more prediction results may comprise one or more received power indicators predicted in a time domain or a spatial domain.

In some implementations, the communication apparatus 310 may fix the AoA and a beam direction of the predetermined receiving beam when receiving the one or more reference signals.

In some implementations, the communication apparatus 310 may keep the predetermined receiving beam fixed and does not switch the receiving beam in the test procedure after aligning the AoA and the beam direction. In some implementations, the communication apparatus 310 may lock the AoA or lock the receiving beam in response to a command issued by the test equipment 320.

In some implementations, in the calibration procedure, the communication apparatus 310 may receive the calibration signal from the test equipment 320, determine a metric value associated with the calibration signal, and transmit the metric value to the test equipment 320.

### Illustrative Implementations

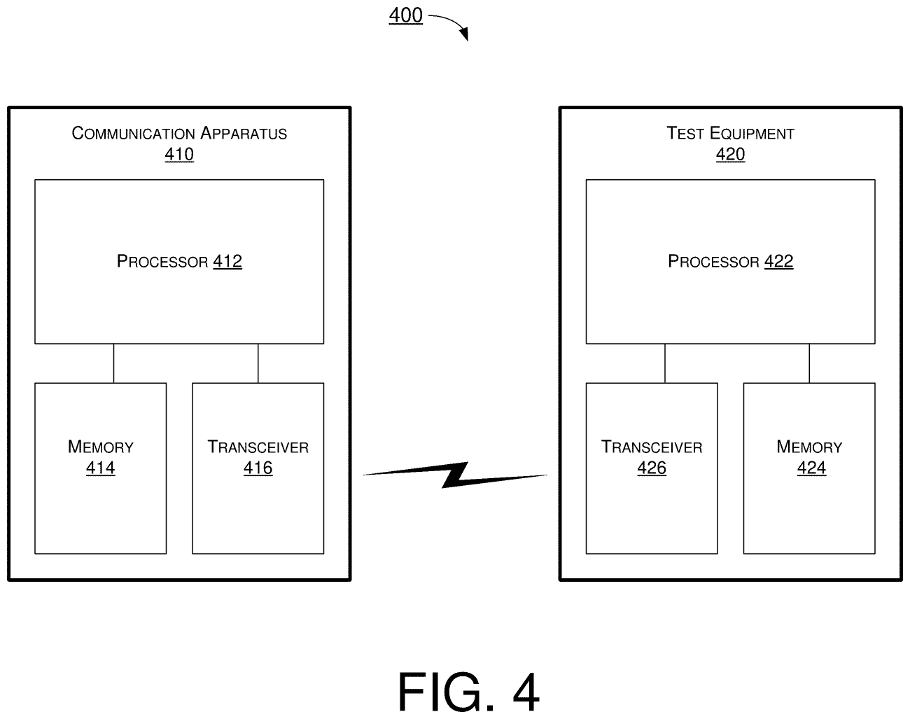

FIG. 4 illustrates an example communication system 400 having an example communication apparatus 410 and an example test equipment 420 in accordance with an implementation of the present disclosure. Each of the communication apparatus 410 and the test equipment 420 may perform various functions to implement schemes, techniques, processes and methods described herein pertaining to performance evaluation of a prediction model utilized in mobile communications, including scenarios/schemes described above as well as the process 500 and the process 600 described below.

The communication apparatus 410 may be a part of an electronic apparatus, which may be a UE such as a portable or mobile apparatus, a wearable apparatus, a wireless communication apparatus or a computing apparatus. For instance, the communication apparatus 410 may be implemented in a smartphone, a smartwatch, a personal digital assistant, a digital camera, or a computing equipment such as a tablet computer, a laptop computer or a notebook computer. The communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 410 may be implemented in a smart thermostat, a smart fridge, a smart door lock, a wireless speaker or a home control center. Alternatively, the communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 410 may include at least some of those components shown in FIG. 4 such as a processor 412, for example. The communication apparatus 410 may further include one or more other components not pertinent to the proposed scheme of the present disclosure (e.g., internal power supply, display device and/or user interface device), and, thus, such component(s) of the communication apparatus 410 are neither shown in FIG. 4 nor described below in the interest of simplicity and brevity.

The test equipment 420 may simulate transmitting and receiving behaviors of a network device, which may be a network node such as a satellite, a base station, a small cell, a router or a gateway. For instance, the test equipment 420 may simulate an eNodeB in an LTE network, in a gNB in a 5G/NR, IoT, NB-IoT or IIoT network or in a satellite or base station in a 6G network. The test equipment 420 may be implemented in the form of one or more IC chips such as, for example and without limitation, one or more single-core processors, one or more multi-core processors, or one or more RISC or CISC processors. The test equipment 420 may include at least some of those components shown in FIG. 4 such as a processor 422, for example. The test equipment 420 may further include one or more other components not pertinent to the proposed scheme of the present disclosure (e.g., internal power supply, display device and/or user interface device), and, thus, such component(s) of the test equipment 420 are neither shown in FIG. 4 nor described below in the interest of simplicity and brevity.

In one aspect, each of the processor 412 and the processor 422 may be implemented in the form of one or more single-core processors, one or more multi-core processors, or one or more CISC processors. That is, even though a singular term “a processor” is used herein to refer to the processor 412 and the processor 422, each of the processor 412 and the processor 422 may include multiple processors in some implementations and a single processor in other implementations in accordance with the present disclosure. In another aspect, each of the processor 412 and the processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 412 and the processor 422 is a special-purpose machine specifically designed, arranged and configured to perform specific tasks in accordance with various implementations of the present disclosure.

In some implementations, communication apparatus 410 may also include a transceiver 416 coupled to processor 412 and capable of wirelessly transmitting and receiving data. In some implementations, transceiver 416 may be capable of wirelessly communicating with different types of UEs and/or wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, test equipment 420 may also include a transceiver 426 coupled to processor 422. Transceiver 426 may include a transceiver capable of wirelessly transmitting and receiving data. In some implementations, transceiver 426 may be capable of wirelessly communicating with different types of UEs of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, communication apparatus 410 may further include a memory 414 coupled to processor 412 and capable of being accessed by processor 412 and storing data therein. In some implementations, test equipment 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 410 and test equipment 420 may be a communication entity capable of communicating with each other using various proposed schemes in accordance with the present disclosure. For illustrative purposes and without limitation, a description of capabilities of communication apparatus 410, as a UE, and test equipment 420, as a network node, is provided below with processes 500 and 600.

### Illustrative Processes

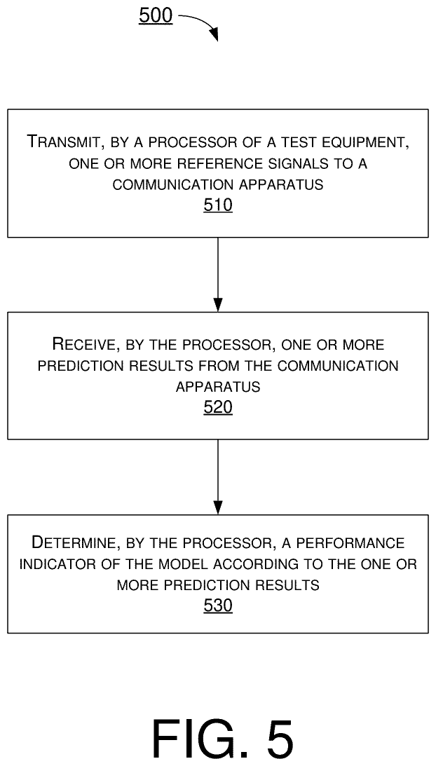

FIG. 5 illustrates an example process 500 in accordance with an implementation of the present disclosure. The process 500 may be an example implementation of above scenarios/schemes, whether partially or completely, including those described above with respect to performance evaluation of a model. The process 500 may represent an aspect of implementation of features of the test equipment 420. The process 500 may include one or more operations, actions, or functions as illustrated by one or more of blocks 510, 520 and 530. Although illustrated as discrete blocks, various blocks of the process 500 may be divided into additional blocks, combined into fewer blocks, or eliminated, depending on the desired implementation. Moreover, the blocks of the process 500 may be executed in the order shown in FIG. 5 or, alternatively, in a different order. The process 500 may be implemented by the test equipment 420. Solely for illustrative purposes and without limitation, the process 500 is described below in the context of the test equipment 420. The process 500 may begin at block 510.

At block 510, the process 500 may involve the processor 422 of the test equipment 420 transmitting one or more reference signals to the communication apparatus 410. The process 500 may proceed from block 510 to block 520.

At block 520, the process 500 may involve the processor 422 receiving one or more prediction results from the communication apparatus 410. The one or more prediction results may be output by a model of the communication apparatus 410 based on the one or more reference signals. The process 500 may proceed from block 520 to block 530.

At block 530, the process 500 may involve the processor 422 determining a performance indicator of the model according to the one or more prediction results.

In some implementations, the one or more reference signals may be transmitted according to an angle of arrival associated with the communication apparatus 410.

In some implementations, the angle of arrival may be fixed when transmitting the one or more reference signals.

In some implementations, the one or more prediction results may comprise one or more received power indicators predicted in a time domain.

In some implementations, the one or more prediction results may comprise one or more received power indicators predicted in a spatial domain.

In some implementations, the process 500 may involve the processor 422 transmitting a configuration to the communication apparatus 410. In some implementations, the configuration may indicate whether a time domain prediction or a spatial domain prediction is to be performed.

In some implementations, the process 500 may involve the processor 422 controlling a transmission power of the one or more reference signals. In some implementations, the transmission power may reflect at least one of a channel between the test equipment 420 and the communication apparatus 410, a number of transmitting beams of the test equipment 420, an antenna configuration of the test equipment 420, an antenna radiation pattern of the test equipment 420, an antenna configuration of the communication apparatus 410, an antenna radiation pattern of the communication apparatus 410 and a speed of the communication apparatus 410.

In some implementations, the process 500 may involve the processor 422 transmitting a calibration signal with a predetermined power to the communication apparatus 410, receiving a metric value associated with the calibration signal from the communication apparatus 410 and determining a transmission power of the one or more reference signals according to a relationship between the metric value and the predetermined power.

In some implementations, an angle of arrival of the calibration signal and an angle of arrival of the one or more reference signals may be the same.

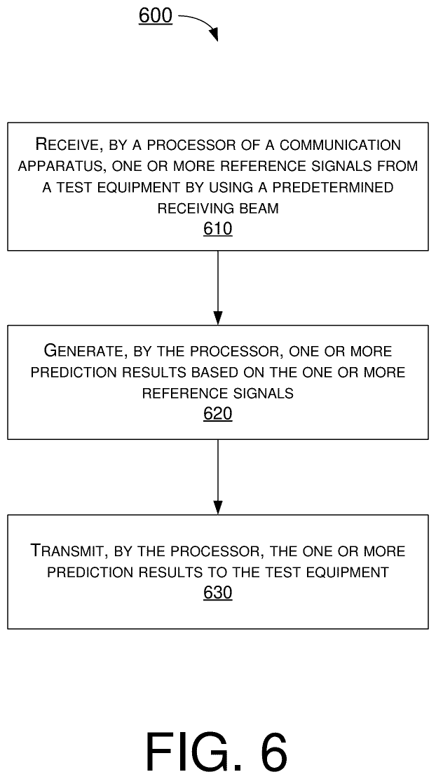

FIG. 6 depicting an example process 600 in accordance with an implementation of the present disclosure. The process 600 may be an example implementation of above scenarios/schemes, whether partially or completely, including those described above with respect to performance evaluation of a model. The process 600 may represent an aspect of implementation of features of the communication apparatus 410. The process 600 may include one or more operations, actions, or functions as illustrated by one or more of blocks 610, 620 and 630. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the communication apparatus 410 or any suitable UE or machine type devices. Solely for illustrative purposes and without limitation, the process 600 is described below in the context of the communication apparatus 410. The process 600 may begin at block 610.

At block 610, the process 600 may involve the processor 412 of the communication apparatus 410 receiving one or more reference signals from the test equipment 420 by using a predetermined receiving beam. The process 600 may proceed from block 610 to block 620.

At block 620, the process 600 may involve the processor 412 generating one or more prediction results based on the one or more reference signals. The process 600 may proceed from block 620 to block 630.

At block 630, the process 600 may involve the processor 412 transmitting the one or more prediction results to the test equipment. In some implementations, the one or more prediction results may comprise one or more received power indicators predicted in a time domain or a spatial domain.

In some implementations, the process 600 may involve the processor 412 fixing an angle of arrival and a beam direction of the predetermined receiving beam when receiving the one or more reference signals.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of a test equipment, one or more reference signals to a communication apparatus;
receiving, by the processor, one or more prediction results from the communication apparatus, wherein the one or more prediction results are output by a model of the communication apparatus based on the one or more reference signals; and
determining, by the processor, a performance indicator of the model according to the one or more prediction results.

2. The method of claim 1, wherein the one or more reference signals are transmitted according to an angle of arrival associated with the communication apparatus.

3. The method of claim 2, wherein the angle of arrival is fixed when transmitting the one or more reference signals.

4. The method of claim 1, wherein the one or more prediction results comprise one or more received power indicators predicted in a time domain.

5. The method of claim 1, wherein the one or more prediction results comprise one or more received power indicators predicted in a spatial domain.

6. The method of claim 1, further comprising:
transmitting, by the processor, a configuration to the communication apparatus,
wherein the configuration indicates whether a time domain prediction or a spatial domain prediction is to be performed.

7. The method of claim 1, further comprising:
controlling, by the processor, a transmission power of the one or more reference signals,
wherein the transmission power reflects at least one of a channel between the test equipment and the communication apparatus, a number of transmitting beams of the test equipment, an antenna configuration of the test equipment, an antenna radiation pattern of the test equipment, an antenna configuration of the communication apparatus, an antenna radiation pattern of the communication apparatus and a speed of the communication apparatus.

8. The method of claim 1, further comprising:
transmitting, by the processor, a calibration signal with a predetermined power to the communication apparatus;
receiving, by the processor, a metric value associated with the calibration signal from the communication apparatus; and
determining, by the processor, a transmission power of the one or more reference signals according to a relationship between the metric value and the predetermined power.

9. The method of claim 8, wherein an angle of arrival of the calibration signal and an angle of arrival of the one or more reference signals are the same.

10. A test equipment, comprising:
a transceiver which, during operation, wirelessly communicates with at least one communication apparatus; and
a processor communicatively coupled to the transceiver such that, during operation, the processor performs operations comprising:
transmitting, via the transceiver, one or more reference signals to the communication apparatus;
receiving, via the transceiver, one or more prediction results from the communication apparatus, wherein the one or more prediction results are output by a model of the communication apparatus based on the one or more reference signals; and
determining a performance indicator of the model according to the one or more prediction results.

11. The test equipment of claim 10, wherein the one or more reference signals are transmitted according to an angle of arrival associated with the communication apparatus.

12. The test equipment of claim 11, wherein the angle of arrival is fixed when transmitting the one or more reference signals.

13. The test equipment of claim 10, wherein the one or more prediction results comprise one or more received power indicators predicted in a time domain.

14. The test equipment of claim 10, wherein the one or more prediction results comprise one or more received power indicators predicted in a spatial domain.

15. The test equipment of claim 10, wherein the processor further performs operation comprising:
transmitting, via the transceiver, a configuration to the communication apparatus,
wherein the configuration indicates whether a time domain prediction or a spatial domain prediction is to be performed.

16. The test equipment of claim 10, wherein, in transmitting the one or more reference signals, the processor further performs operation comprising:
controlling a transmission power of the one or more reference signals,
wherein the transmission power reflects at least one of a channel between the test equipment and the communication apparatus, a number of transmitting beams of the test equipment, an antenna configuration of the test equipment, an antenna radiation pattern of the test equipment, an antenna configuration of the communication apparatus, an antenna radiation pattern of the communication apparatus and a speed of the communication apparatus.

17. The test equipment of claim 10, wherein, before transmitting the one or more reference signals, the processor further performs operations comprising:
transmitting, via the transceiver, a calibration signal with a predetermined power to the communication apparatus;
receiving, via the transceiver, a metric value associated with the calibration signal from the communication apparatus; and
determining a transmission power of the one or more reference signals according to a relationship between the metric value and the predetermined power.

18. The test equipment of claim 17, wherein an angle of arrival of the calibration signal and an angle of arrival of the one or more reference signals are the same.

19. A method, comprising:
receiving, by a processor of a communication apparatus, one or more reference signals from a test equipment by using a predetermined receiving beam;
generating, by the processor, one or more prediction results based on the one or more reference signals; and
transmitting, by the processor, the one or more prediction results to the test equipment,
wherein the one or more prediction results comprise one or more received power indicators predicted in a time domain or a spatial domain.

20. The method of claim 19, further comprising:
fixing, by the processor, an angle of arrival and a beam direction of the predetermined receiving beam when receiving the one or more reference signals.
